(19) United States
(12) Patent Application Publication
(10) Pub. No.: US 2011/0285819 A1
(43) Pub. Date: Nov. 24, 2011

(54) VIDEO SIGNAL PROCESSING APPARATUS AND VIDEO SIGNAL PROCESSING METHOD

(75) Inventor: Kazuo NAKAMURA, Osaka (JP)

(73) Assignee: PANASONIC CORPORATION, Osaka (JP)

(21) Appl. No.: 13/192,930

(22) Filed: Jul. 28, 2011

Related U.S. Application Data
(63) Continuation of application No. PCT/JP2010/004113, filed on Jun. 21, 2010.

(30) Foreign Application Priority Data
Sep. 17, 2009 (JP) 2009-216273

(51) Int. Cl. H04N 13/00

(52) U.S. Cl. 348/43; 348/E13.001

(57) ABSTRACT

To provide a video signal processing apparatus which allows suppressing increase in amount of processing, the video signal processing apparatus processes a 3D video signal including a left eye image and a right eye image, and includes: a film detection unit that is an example of an information obtaining unit which obtains, from one of the left eye image and the right eye image, information used for performing predetermined processing; and an IP conversion unit that is an example of an image processing unit which performs the predetermined processing on both the left eye image and the right eye image, using the information obtained by the information obtaining unit.

### CROSS REFERENCE TO RELATED APPLICATION

This is a continuation application of PCT application No. PCT/JP2010/004113 filed on Jun. 21, 2010, designating the United States of America.

### BACKGROUND OF THE INVENTION

(1) Field of the Invention

The present invention relates to video signal processing apparatuses, and particularly relates to a video signal processing apparatus which processes a three-dimensional (3D) video signal.

(2) Description of the Related Art

Conventionally, for displaying 3D video that can be stereoscopically perceived by a viewer, a video signal processing apparatus which processes a 3D video signal including a left eye image and a right eye image is known (For example, see Japanese Unexamined Patent Application Publication No. 4-241593). The left eye image and the right eye image are images having parallax to each other and, for example, generated by two cameras placed at different positions.

The video signal processing apparatus performs, for example, format conversion processing on the 3D video signal that is input. The format conversion processing includes, for example, processing for frame rate conversion, image size conversion, and scanning mode conversion. The video signal processing apparatus outputs the 3D video signal after converted into another format, to a three-dimensional video display apparatus.

A three-dimensional video display apparatus displays 3D video that can be perceived as stereoscopic by the viewer, by displaying the left eye image and the right eye image in a predetermined manner. For example, the three-dimensional video display apparatus alternately displays the left eye image and right eye image on a per-frame basis.

### SUMMARY OF THE INVENTION

However, the conventional technique described above has a problem of increase in amount of processing involved in the 3D video signal.

In order to display 3D video with the same quality at the same frame rate as two-dimensional (2D) video, it is necessary to perform processing whose amount is double the amount of processing to be performed on the 2D image. This is because in the 3D video, a frame of 3D video is composed of two 2D images, that is, the left eye image and right eye image. This accordingly involves processing of the two 2D images, thus increasing the amount of processing.

Thus, an object of the present invention, which is conceived to solve the above problem, is to provide a video signal processing apparatus and a video signal processing method which allow suppressing increase in amount of processing.

To achieve the above object, a video signal processing apparatus according to an aspect of the present invention is a video signal processing apparatus which processes a three-dimensional (3D) video signal including a left eye image and a right eye image, and the video signal processing apparatus includes: an information obtaining unit which obtains, from one of the left eye image and the right eye image, image feature information used for performing predetermined processing; and an image processing unit which performs the predetermined processing on both the left eye image and the right eye image, using the image feature information obtained by the information obtaining unit.

This allows use of information obtained from either the left eye image or the right eye image for processing both the left eye image and the right eye image, thus making it possible to avoid overlaps in processing and suppress increase in amount of processing. Since the left eye image and the right eye image are normally generated by imaging the same object from different viewpoints, it often happens that the same result is obtained when predetermined processing is performed on each of the left eye image and the right eye image, thus allowing sharing the result.

In addition, the information obtaining unit may obtain film information by performing film detection on the one of the left eye image and the right eye image, the film information indicating whether or not the 3D video signal is a video signal generated from film images.

This allows sharing the result of the film detection between the left eye image and the right eye image. The film detection is an example of image feature detection processing, and is processing for detecting whether or not the 3D video signal is a video signal generated from film images. By performing the film detection, it is normally possible to obtain the same detection result for the left eye image and the right eye image. Accordingly, by sharing the result of the film detection, it is possible to avoid overlaps in the processing, thus allowing suppressing increase in amount of processing.

In addition, the information obtaining unit may further obtain picture information when the 3D video signal is the video signal generated from the film images, the picture information indicating pictures generated from a same frame among a plurality of frames in the film images, and when the film information indicates that the 3D video signal is the video signal generated from the film images, the image processing unit may perform, using the picture information, at least one of a scanning mode conversion and a frame rate conversion as the predetermined processing on each of the left eye image and the right eye image.

With this, it is possible to suppress increase in amount of processing when performing scanning mode conversion or frame rate conversion on the video signal generated from the film images.

In addition, the information obtaining unit may obtain specific image information by detecting whether or not the one of the left eye image and the right eye image includes a specific image having a constant luminance value, the specific image information indicating a region including the specific image.

This allows sharing the result of the detection of the specific image between the left eye image and the right eye image. The specific image, for example, is an image having a constant luminance value, and is an image to be added to an original image for the purpose of adjusting an aspect ratio. Since the specific image is normally added to the same region in the left eye image and the right eye image, it is only necessary to detect the specific image from either the left eye image or the right eye image, thus making it possible to avoid overlaps in the processing.

In addition, the information obtaining unit may obtain the specific image information by detecting whether or not the one of the left eye image and the right eye image includes the specific image on right and left sides of the one of the left eye image and the right eye image.

This allows detecting what is called a side panel (pillar box).

In addition, the information obtaining unit may obtain the specific image information by detecting whether or not the one of the left eye image and the right eye image includes the specific image on top and bottom sides of the one of the left eye image and the right eye image.

This allows detecting what is called a letter box.

In addition, the image processing unit may calculate, for each of the left eye image and the right eye image, an average luminance value of an effective image region that is other than the region indicated by the specific image information.

With this, an average luminance value of the original image can be calculated by calculating an average luminance value of an effective image region that is other than a region of the specific image. This comes from the fact that calculating the average luminance value of the entire region of the image generally results in a value different from the average luminance value of the original image because the detected specific image is not an original image.

In addition, the video signal processing apparatus may further include a division unit which divides the 3D video signal into the left eye image and the right eye image, and the image processing unit may include: a left-eye image processing unit which performs the predetermined processing on the left eye image; and a right-eye image processing unit which performs the predetermined processing on the right eye image, and the information obtaining unit may obtain the image feature information from the one of the left eye image and the right eye image that have resulted from the division by the division unit, and may output the obtained image feature information to the left-eye image processing unit and the right-eye image processing unit.

This allows processing the left eye image and the right eye image in parallel, thus allowing increase in processing speed.

Note that the present invention can be realized not only as a video signal processing apparatus as described above but also as a method including, as steps, processing units included in the video signal processing apparatus. In addition, the present invention may also be realized as a program causing a computer to execute these steps. Furthermore, the present invention may be realized as: a non-transitory computer-readable recording medium for the computer such as a compact disc-read only memory (CD-ROM), and information, data, or a signal which represents the program. In addition, these program, information, data, and signal may be distributed via a communication network such as the Internet.

In addition, each of part or all of the constituent elements included the video signal processing apparatus above may include one system large scale integration (LSI). The system LSI is a super multifunctional LSI manufactured by integrating a plurality of constituent parts on a single chip, and is specifically a computer system configured including a microprocessor, a read-only memory (ROM) or random access memory (RAM), or the like.

With the video signal processing apparatus and the video signal processing method according to the present invention, it is possible to suppress increase in amount of processing.

Further Information about Technical Background to this Application

The disclosure of Japanese Patent Application No. 2009-216273 filed on Sep. 17, 2009 including specification, drawings and claims is incorporated herein by reference in its entirety.

The disclosure of PCT application No. PCT/JP2010/004113 filed on Jun. 21, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a video signal processing system including a video signal processing apparatus according to a first embodiment;

FIG. 2A is a diagram showing an example of a layout pattern of a 3D video signal according to the first embodiment;

FIG. 2B is a diagram showing an example of a layout pattern of a 3D video signal according to the first embodiment;

FIG. 3 is a block diagram showing a configuration of the video signal processing apparatus according to the first embodiment;

FIG. 4 is a flowchart showing an example of operation performed by the video signal processing apparatus according to the first embodiment;

FIG. 5 is a diagram showing an example of a flow of processing performed on a 3D video signal by the video signal processing apparatus according to the first embodiment;

FIG. 6 is a block diagram showing an example of a configuration of a conversion processing unit according to the first embodiment;

FIG. 7 is a flowchart showing an example of operation performed by the conversion processing unit according to the first embodiment;

FIG. 8 is a diagram showing an example of film images and an input 3D video signal;

FIG. 9 is a diagram showing an example of processing for performing IP conversion from 60i video to 60p video by an IP conversion unit according to the first embodiment;

FIG. 10A is a block diagram showing an example of a configuration of an input selection unit according to a second embodiment;

FIG. 10B is a block diagram showing another example of the configuration of the input selection unit according to the second embodiment;

FIG. 11A is a diagram showing an example of a side panel image;

FIG. 11B is a diagram showing an example of a letter box image;

FIG. 12 is a diagram showing an example of operation performed by the input selection unit according to the second embodiment; and

FIG. 13 is an external view showing an example of a digital video recorder and a digital video television which include a video signal processing apparatus according to the present invention.

### DESCRIPTION OF THE PREFERRED EMBODIMENTS

Hereinafter, a video signal processing apparatus and a video signal processing method according to the present invention will be described based on embodiments with reference to the drawings.

### First Embodiment

A video signal processing apparatus according to a first embodiment is a video signal processing apparatus which processes a three-dimensional (3D) video signal including a left eye image and a right eye image, and the video signal processing apparatus includes: an information obtaining unit which obtains, from one of the left eye image and the right eye image, image feature information used for performing predetermined processing; and an image processing unit which performs the predetermined processing on both the left eye image and the right eye image, using the image feature information obtained by the information obtaining unit. More specifically, in the present embodiment, the information obtaining unit performs film detection that is an example of image feature quantity detection processing, and performs, using the result of the detection, scanning mode conversion or frame rate conversion on each of left-eye video data including the left eye image and right-eye video data including the right image.

First, a video signal processing system including a video signal processing apparatus according to the first embodiment will be described.

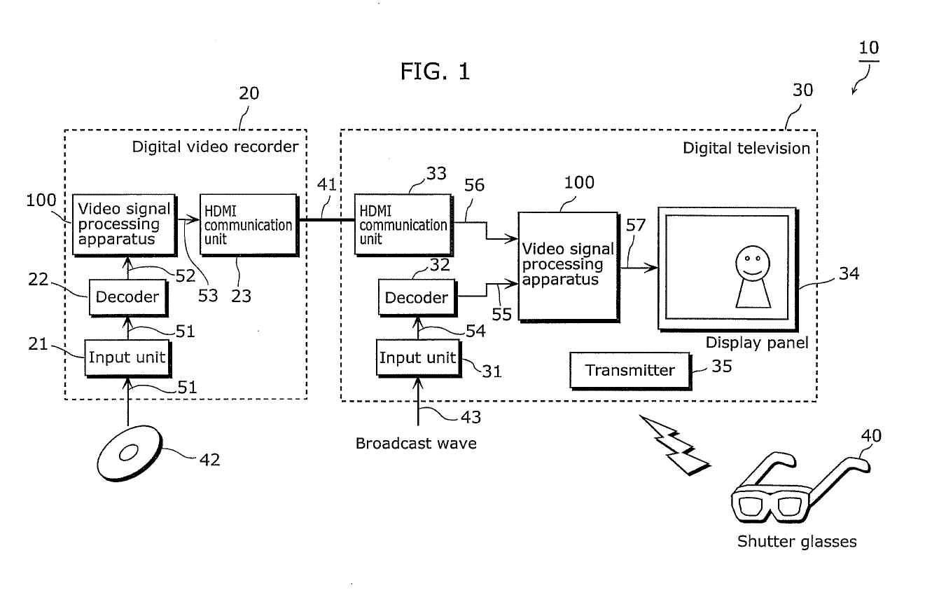

FIG. 1 is a block diagram showing a configuration of a video signal processing system 10 including a video signal processing apparatus 100 according to the first embodiment.

The video signal processing system 10 shown in FIG. 1 includes: a digital video recorder 20, a digital television 30, and shutter glasses 40. In addition, the digital video recorder 20 and the digital television 30 are connected to each other by a high definition multimedia interface (HDMI) cable 41.

The digital video recorder 20 converts a format of a 3D video signal recorded on a recording medium 42, and outputs the converted 3D video signal to the digital television 30 via the HDMI cable 41. Note that the recording medium 42 is, for example, an optical disk such as a Blu-ray disc (BD), a magnetic disk such as a hard disk drive (HDD), or a nonvolatile memory.

The digital television 30 converts the format of the 3D video signal that is input from the digital video recorder 20 via the HDMI cable 41 or a 3D video signal included in a broadcast wave 43, and displays 3D video included in the converted 3D video signal. Note that the broadcast wave 43 is, for example, terrestrial digital television broadcasting and satellite digital television broadcasting.

The shutter glasses 40 are eye glasses for the viewer to wear for watching the 3D video, and are, for example, liquid crystal shutter glasses. The shutter glasses 40 include a left-eye liquid crystal shutter and a right-eye liquid crystal shutter, and are capable of controlling opening and closing of the shutters in synchronization with the video displayed by the digital television 30.

Note that the digital video recorder 20 may convert the format of the 3D video signal included in the broadcast wave 43 or the 3D video signal obtained via the communication network such as the Internet. In addition, the digital video recorder 20 may convert the format of the 3D video signal that is input from an apparatus provided outside, via an external input terminal (not shown).

Likewise, the digital television 30 may convert the format of the 3D video signal recorded on the recording medium 42. In addition, the digital television 30 may convert the format of a 3D video signal that is input from an apparatus provided outside that is other than the digital video recorder 20, via an external input terminal (not shown).

In addition, the digital video recorder 20 and the digital television 30 may be connected to each other by a cable compliant with another specification than the HDMI cable 41, or may be connected by a wireless communication network.

The following will describe the detailed configurations of the digital video recorder 20 and the digital television 30. First, the digital video recorder 20 is described.

As shown in FIG. 1, the digital video recorder 20 includes: an input unit 21, a decoder 22, a video signal processing apparatus 100, and an HDMI communication unit 23.

The input unit 21 obtains a 3D video signal 51 recorded on the recording medium 42. The 3D video signal 51, for example, includes coded 3D video that is compression-coded according to such standards as MPEG-4 or AVC/H.264.

The decoder 22 generates an input 3D video signal 52 by decoding the 3D video signal 51 obtained by the input unit 21.

The video signal processing apparatus 100 generates an output 3D video signal 53 by processing the input 3D video signal 52 generated by the decoder 22. The detailed configuration and operation of the video signal processing apparatus 100 will be described later.

The HDMI communication unit 23 outputs the output 3D video signal 53 generated by the video signal processing apparatus 100, to the digital television 30 via the HDMI cable 41.

Note that the digital video recorder 20 may record the generated output 3D video signal into a memory unit (such as a HDD and a nonvolatile memory) included in the digital video recorder 20. Alternatively, the digital video recorder 20 may record the output 3D video signal onto a recording medium that is removable for the digital video recorder (such as an optical disc).

In addition, when connected to the digital television 30 by another means than the HDMI cable 41, the digital video recorder 20 may include, instead of the HDMI communication unit 23, a communication unit compatible with the means. For example, the digital video recorder 20 includes a wireless communication unit when the means of connection is a wireless communication network, and includes, when the means of connection is a cable compliant with another specification, a communication unit compliant with the specification. Note that the digital video recorder 20 may include such communication units as described above and switch these communication units when using them.

Next, the digital television 30 is described.

As shown in FIG. 1, the digital television 30 includes: an input unit 31, a decoder 32, an HDMI communication unit 33, a video signal processing apparatus 100, a display panel 34, and a transmitter 35.

The input unit 31 obtains a 3D video signal 54 included in the broadcast wave 43. The 3D video signal 54, for example, includes coded 3D video that is compression-coded according to such standards as MPEG-4 or AVC/H.264.

The decoder 32 generates an input 3D video signal 55 by decoding the 3D video signal 54 obtained by the input unit 31.

The HDMI communication unit 33 obtains the output 3D video signal 53 that is output from the HDMI communication unit 23 in the digital video recorder 20, and outputs the obtained output 3D video signal 53 to the video signal processing apparatus 100 as an input 3D video signal 56.

The video signal processing apparatus 100 generates an output 3D video signal 57 by processing the input 3D video signals 55 and 56. The detailed configuration and operation of the video signal processing apparatus 100 will be described later.

The display panel 34 displays 3D video included in the output 3D video signal 57.

The transmitter 35 controls opening and closing of the shutters of the shutter glasses 40, using a wireless communication.

Note that, as with the case of the digital video recorder 20, when connected to the digital video recorder 20 by another means than the HDMI cable 41, the digital television 30 may include, instead of the HDMI communication unit 33, a communication unit compatible with the means.

Here, the 3D video displayed by the display panel 34 is described, and the method of synchronizing the display panel 34 and the shutter glasses 40 is described.

The 3D video includes a left eye image and a right eye image having parallax to each other. The left eye image and the right eye image, when caused to be selectively incident, respectively, onto the left eye and the right eye of a viewer allow the viewer to stereoscopically perceive the video.

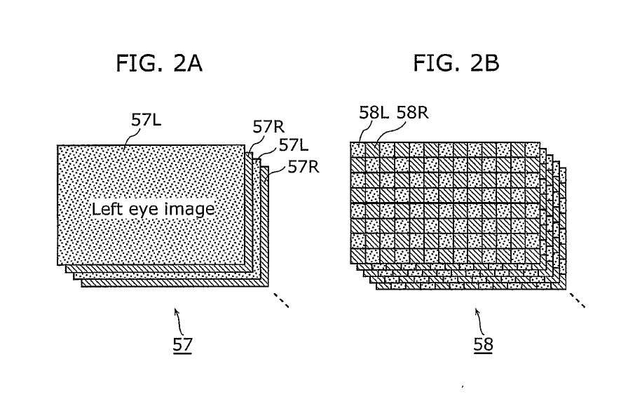

FIG. 2A shows an example of the output 3D video signal 57 generated by the video signal processing apparatus 100 included in the digital television 30. Note that FIG. 2A is a diagram showing an example of a layout pattern of a 3D video signal according to the first embodiment.

The output 3D video signal 57 shown in FIG. 2A includes, alternately per frame, a left eye image 57L and a right eye image 57R. For example, a frame rate of the output 3D video signal 57 is 120 fps, and the scanning mode is a progressive format. Note that such a video signal is also described as a 120p video signal.

The display panel 34 receives the output 3D video signal 57 shown in FIG. 2A and displays, alternately per frame, the left eye image 57L and the right eye image 57R. In this processing, the transmitter 35 controls the shutter glasses 40 such that the left-eye liquid crystal shutter of the shutter glasses 40 opens and the right-eye liquid crystal shutter is closed during a period when the display panel 34 displays the left eye image 57L. In addition, the transmitter 35 opens the right-eye liquid crystal shutter of the shutter glasses 40 during a period when the display panel 34 displays the right eye image 57R, and also controls the shutter glasses 40 such that the left-eye liquid crystal shutter is closed. With this, the left eye image 57L and the right eye image 57R are selectively incident, respectively, on the left eye and the right eye of the viewer.

Thus, the display panel 34 displays images by temporally switching between the left eye image 57L and the right eye image 57R.

Note that in the example shown in FIG. 2A, the left eye image 57L and the right eye image 57R are switched on a-per frame basis, but may also be switched on a basis of a plurality of frames.

Note that the method of causing selective incidence of the left eye image and the right eye image onto, respectively, the left eye and the right eye of the viewer is not limited to the method described above, but another method may be used.

For example, the video signal processing apparatus 100 included in the digital television 30 may generate an output 3D video signal 58 as shown in FIG. 2B. The output 3D video signal 58 that is generated is output to the display panel 34. Note that FIG. 2B is a diagram showing an example of a layout pattern of a 3D video signal according to the first embodiment.

For example, the output 3D video signal 58 shown in FIG. 2B includes the left eye image 58L and the right eye image 58R in different regions within one frame. Specifically, the left eye image 58L and the right eye image 58R are arranged in a checked pattern. For example, a frame rate of the output 3D video signal 58 is 60 fps, and the progressive format is used for the scanning mode. Note that such a video signal is also described as a 60p video signal.

The display panel 34 receives the output 3D video signal 58 shown in FIG. 2B, and displays an image in which the left eye image 58L and the right eye image 58R are arranged in a checked pattern. In this case, the display panel 34 includes a left-eye polarizing film formed on pixels in which the left eye image 58L is displayed, and a right-eye polarizing film formed on pixels in which the right eye image 58R is displayed. With this, polarization that differs between the images (linear polarization, circular polarization, or the like) is performed on each of the left eye image 58L and the right eye image 58R.

Furthermore, the viewer wears polarizing glasses including, instead of the shutter glasses 40, the left-eye polarizing filter and the right-eye polarizing filter each of which corresponds to one of the different polarization films included in the display panel 34. This allows causing the left eye image 58L and the right eye image 58R to be selectively incident onto, respectively, the left eye and the right eye of the viewer.

Thus, the display panel 34 displays video in which the left eye image 58L and the right eye image 58R are arranged in spatially different regions within one frame. Note that in the example shown in FIG. 2B, the left eye image 58L and the right eye image 58R are arranged for each pixel, but the left eye image 58L and the right eye image 58R may be arranged on the basis of a plurality of pixels. In addition, such left eye and right eye images 58L and 58R need not necessarily be arranged in a checked pattern, but may be arranged in each horizontal line or in each vertical line.

Hereinafter, the configuration and operation of the video signal processing apparatus 100 according to the first embodiment will be described in detail.

The video signal processing apparatus 100 according to the first embodiment processes a 3D video signal including a left eye image and a right eye image. Specifically, the video signal processing apparatus 100 performs format conversion processing on the 3D video signal that is input. For example, the video signal processing apparatus 100 included in the digital video recorder 20 converts the input 3D video signal 52 of a first format into the output 3D video signal 53 of a second format.

Here, the format conversion processing performed by the video signal processing apparatus 100 is processing for converting at least one of: the layout pattern, the frame rate, the scanning mode, and the image size. Note that the video signal processing apparatus 100 may perform processing other than these.

The layout pattern conversion is converting a temporal layout or a spatial layout of the left eye image and the right eye image that are included in the 3D video signal. For example, the video signal processing apparatus 100 converts the 3D video signal shown in FIG. 2A into the 3D video signal shown in FIG. 2B.

The frame rate conversion is converting the frame rate of the 3D video signal. For example, the video signal processing apparatus 100 converts a 3D video signal of low frame rate (for example, 60 fps) into a 3D video signal of high frame rate (for example, 120 fps) by performing frame interpolation or frame copying. Alternatively, the video signal processing apparatus 100 converts a 3D video signal of high frame rate into a 3D video signal of low frame rate by generating a frame by thinning out the frames or temporally averaging a plurality of frames.

The scanning mode conversion is conversion from the interlace format to the progressive format, or conversion from the progressive format to the interlace format. Note that the interlace format is a method of dividing a frame into a top field made up of odd-numbered lines and a bottom field made up of even-numbered lines and scanning the top and bottom fields separately.

The image size conversion is to enlarge or reduce image size. For example, the video signal processing apparatus 100 enlarges an image by interpolating or copying pixel signals. Alternatively, the video signal processing apparatus 100 reduces the image by thinning out pixels or calculating an average value of a plurality of pixel values. For example, the image size includes: VGA (640×480), high-vision image (1280×720), and full high-vision image (1920×1080).

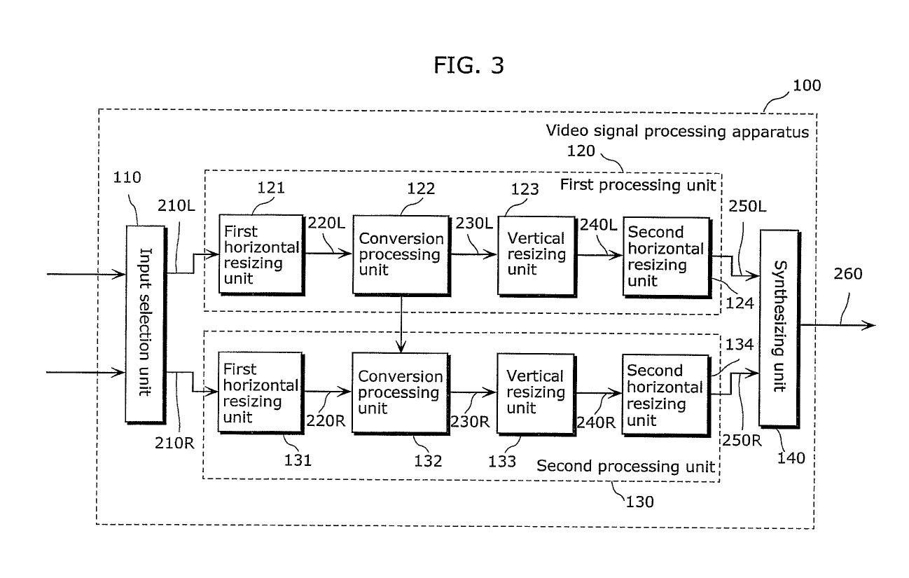

FIG. 3 is a block diagram showing a configuration of a video signal processing apparatus 100 according to the first embodiment.

The video signal processing apparatus 100 shown in FIG. 3 includes: an input selection unit 110, a first processing unit 120, a second processing unit 130, and a synthesizing unit 140.

The input selection unit 110 divides the input 3D video signal into a left eye image 210L and a right eye image 210R, outputs the left eye image 210L to the first processing unit 120, and outputs the right eye image 210R to the second processing unit 130. Specifically, the input selection unit 110 divides the input 3D video signal into: left-eye video data including only the left eye image out of the left eye image and the right eye image, and right-eye video data including only the right eye image. Then, the input selection unit 110 outputs the left-eye video data to the first processing unit 120, and outputs the right-eye video data to the second processing unit 130. Note that the input selection unit 110 may output the input 3D video signal to each of the first processing unit 120 and the second processing unit 130, and the first processing unit 120 may extract the left-eye video data, and the second processing unit 130 may extract the right-eye video data.

The first processing unit 120 processes the left-eye video data that is input from the input selection unit 110. Specifically, the first processing unit 120 converts the format of the left-eye video data. In this processing, the first processing unit 120 obtains, from the left-eye video data, information used for performing predetermined processing, and outputs the obtained information to the second processing unit 130. For example, by performing image feature detection processing on the left-eye video data that is input, the first processing unit 120 obtains predetermined information as a result of the feature detection. The image feature detection processing is, for example, film detection. The details of the film detection will be described later.

The second processing unit 130 processes the right-eye video data that is input from the input selection unit 110. Specifically, the second processing unit 130 converts the format of the right-eye video data. In this processing, the second processing unit 130 receives information that is obtained by the first processing unit 120 from the left-eye video data. Then, the second processing unit 130 performs predetermined processing on the right-eye video data using the received information.

The synthesizing unit 140 generates a synthesized image 260 by synthesizing the converted left eye image 250L generated by the first processing unit 120 and the converted right eye image 250R generated by the second processing unit 130. The video signal including the generated synthesized image 260 is output as an output 3D video signal.

The details of the configuration of the first processing unit 120 are as follows.

As shown in FIG. 3, the first processing unit 120 includes: a first horizontal resizing unit 121, a conversion processing unit 122, a vertical resizing unit 123, and a second horizontal resizing unit 124.

The first horizontal resizing unit 121 resizes, that is, enlarges or reduces a horizontal size of the left eye image 210L that is input. For example, the first horizontal resizing unit 121 reduces the left eye image 210L in a horizontal direction by thinning out pixels or calculating an average value of a plurality of pixels. The reduced left eye image 220L is output to the conversion processing unit 122.

The conversion processing unit 122 performs IP conversion on the reduced left eye image 220L that is input. The IP conversion is an example of the scanning mode conversion that is to convert the scanning mode for the reduced left eye image 220L from the interlace format to the progressive format. The IP-converted left eye image 230L is output to the vertical resizing unit 123.

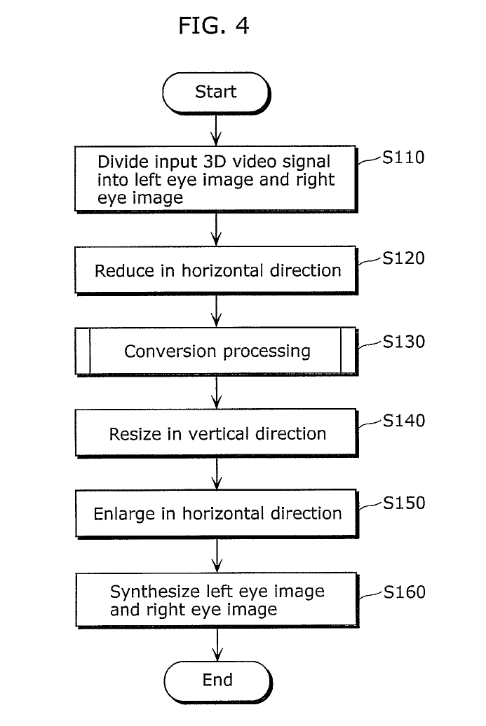

Note that the conversion processing unit 122 obtains, from the left eye image 220L, the information used for the predetermined processing, and outputs the obtained information to the second processing unit 130. In addition, the conversion processing unit 122 may perform noise reduction processing (NR processing). The detailed configuration and operation of the conversion processing unit 122 will be described later with reference to FIG. 4. In addition, the predetermined processing and the information used for the predetermined processing will also be described later.

The vertical resizing unit 123 resizes, that is, enlarges or reduces a vertical size of the left eye image 230L that is IP-converted by the conversion processing unit 122. The resized left eye image 240L is output to the second horizontal resizing unit 124.

The second horizontal resizing unit 124 resizes, that is, enlarges or reduces a horizontal size of the resized left eye image 240L. For example, the second horizontal resizing unit 124 enlarges the resized left eye image 240L in a horizontal direction by interpolating or copying pixel signals. The enlarged left eye image 250L is output to the synthesizing unit 140.

In addition, the details of the configuration of the second processing unit 130 are as follows.

As shown in FIG. 3, the second processing unit 130 includes: a first horizontal resizing unit 131, a conversion processing unit 132, a vertical resizing unit 133, and a second horizontal resizing unit 134.

The first horizontal resizing unit 131 resizes, that is, enlarges or reduces a horizontal size of the right eye image 210R that is input. For example, the second horizontal resizing unit 131 reduces the right eye image 210R in a horizontal direction by thinning out pixels or calculating an average value of a plurality of pixels. The reduced right eye image 220R is output to the conversion processing unit 132.

The conversion processing unit 132 performs the IP conversion on the reduced right eye image 220R that is input. The IP conversion is converting the scanning mode for the reduced right eye image 220R from the interlace format to the progressive format. The IP-converted left eye image 230R is output to the vertical resizing unit 133.

Note that the conversion processing unit 132 obtains information used for predetermined processing from the conversion processing unit 122 in the first processing unit 120. In addition, the conversion processing unit 132 may perform noise reduction processing (NR processing).

The vertical resizing unit 133 resizes, that is, enlarges or reduces a vertical size of the right eye image 230R that is IP-converted by the conversion processing unit 132. The resized right eye image 240R is output to the second horizontal resizing unit 134.

The second horizontal resizing unit 134 resizes, that is, enlarges or reduces a horizontal size of the resized right eye image 240R. For example, the second horizontal resizing unit 134 enlarges the resized right eye image 240R in a horizontal direction by interpolating or copying pixel signals. The enlarged right eye image 250R is output to the synthesizing unit 140.

Note that the input selection unit 110 may output the left eye image 210L to the second processing unit 130, and output the right eye image 210R to the first processing unit 120. In addition, when receiving, as the input 3D video signal, input of two video signals, that is, the left eye video signal representing only the left eye image and the right eye video signal representing only the right eye image, the input selection unit 110 may output the left eye video signal to the first processing unit 120 and output the right eye video signal to the second processing unit 130, without performing division processing.

As described above, the video signal processing apparatus 100 according to the first embodiment obtains information from either the left eye image or the right eye image, and processes both the left eye image and the right eye image using the obtained information.

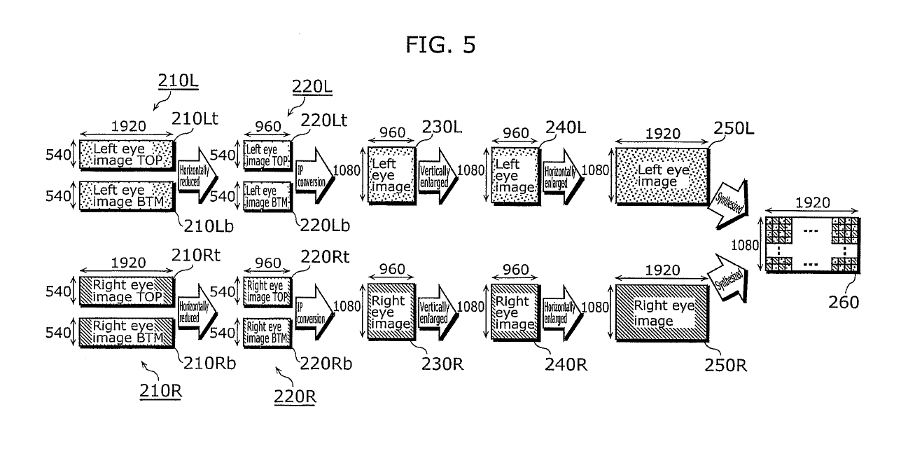

Next, the processing to be performed by the video signal processing apparatus 100 above will be described with reference to FIGS. 4 and 5. Note that FIG. 4 is a flowchart showing an example of the operation performed by the video signal processing apparatus 100 according to the first embodiment. FIG. 5 is a diagram showing an example of a flow of processing performed on the 3D video signal by the video signal processing apparatus 100 according to the first embodiment.

The following will describe the operation of the video signal processing apparatus 100 included in the digital video recorder 20. Note that the video signal processing apparatus 100 included in the digital television 30 performs the same operation.

First, the input selection unit 110 divides the input 3D video signal 52 into the left eye image 210L and the right eye image 210R (S110). Note that the input 3D video signal 52 according to the first embodiment is an interlaced video signal, and is, for example, full high-vision video.

Accordingly, as shown in FIG. 5, the left eye image 210L includes: a left-eye top field 210Lt and a left-eye bottom field 210Lb. Likewise, the right eye image 210R includes: a right-eye top field 210Rt and a right-eye bottom field 210Rb. Each field includes 1920×540 pixels.

Next, the first horizontal resizing units 121 and 131 reduce the left eye image 210L and the right eye image 210R, respectively, in a horizontal direction (S120). Here, the first horizontal resizing units 121 and 131 reduce the images to half in the horizontal direction. This, as shown in FIG. 5, generates a reduced left eye image 220L and a reduced right eye image 220R. Note that the reduction ratio is not limited to one-half. Note that the first horizontal resizing units 121 and 131 may enlarge, respectively, the left eye image 210L and the right eye image 210R in the horizontal direction.

The reduced left eye image 220L includes a reduced left-eye top field 220Lt and a reduced left-eye bottom field 220Lb. Likewise, the reduced right eye image 220R includes: a reduced right-eye top field 220Rt and a reduced right-eye bottom field 220Rb. Each field includes 960×540 pixels.

Note that each of the first horizontal resizing units 121 and 131 may have a different starting point so as to generate an image having a checked pattern as shown in FIG. 2B. Specifically, the first horizontal resizing unit 121 generates the reduced left-eye top field 220Lt by extracting even-numbered pixels (0, 2, 4, 6 . . . ) included in the left-eye top field 210Lt. Furthermore, the first horizontal resizing unit 121 generates the reduced left-eye bottom field 220Lb by extracting odd-numbered pixels (1, 3, 5, 7 . . . ) included in the left-eye bottom field 210Lb.

In addition, the first horizontal resizing unit 131 generates the reduced right-eye top field 220Rt by extracting odd-numbered pixels (1, 3, 5, 7 . . . ) included in the right-eye top field 210Rt. Furthermore, the first horizontal resizing unit 131 generates the reduced right-eye bottom field 220Rb by extracting even-numbered pixels (0, 2, 4, 6 . . . ) included in the right-eye bottom field 210Rb.

Next, the conversion processing units 122 and 132 perform the IP conversion on the reduced left eye image 220L and the reduced right-eye image 220R, respectively (S130). The conversion processing units 122 and 132 generate, respectively, a left eye image 230L and a right eye image 230R in the progressive format by performing the IP conversion. Note that the details of the IP conversion will be described later.

Next, the vertical resizing units 123 and 133 resize, that is, enlarge or reduce the left eye image 230L and the right eye image R, respectively, in a vertical direction (S140). In an example shown in FIG. 5, the vertical resizing units 123 and 133 output the left eye image 240L and the right eye image 240R, respectively, without resizing in a vertical direction.

Next, the second horizontal resizing units 124 and 134 enlarge the left eye image 240L and the right eye image 240R, respectively, in the horizontal direction (S150). For example, the second horizontal resizing unit 124 generates a left eye image 250L that is enlarged to double, by copying each pixel included in the left eye image 240L. Likewise, the second horizontal resizing unit 134 generates the right eye image 250R that is enlarged to double, by copying each pixel included in the right eye image 240R.

Note that an enlargement ratio is, for example, an inverse of a reduction ratio used for the reduction processing in the first horizontal resizing units 121 and 131. However, this is not the only case. The second horizontal resizing units 124 and 134 may reduce, respectively, the left eye image 240L and the right eye image 240R in the horizontal direction.

Lastly, the synthesizing unit 140 generates the synthesized image 260 by synthesizing the left eye image 250L and the right eye image 250R (S160). The synthesized image 260, for example, as shown in FIG. 2B, is an image in which pixels included in the left eye image 250L and pixels included in the right eye image 250R are arranged in a checked pattern. The synthesized image 260 obtained by the synthesis is output as the output 3D video signal 53.

The video signal processing apparatus 100 according to the first embodiment generates the output 3D video signal 53 by processing the input 3D video signal 52.

Next, the following describes: the detailed configuration and operation of the conversion processing unit 122, the information obtained from the left-eye image, and the predetermined processing that is performed using the information.

The conversion processing unit 122 according to the first embodiment performs the film detection before performing the IP conversion. The film detection is an example of the image feature detection processing, and is processing for detecting whether or not the video data is generated from film images. Here, the conversion processing unit 122 detects, as the film detection, whether or not the left-eye video data including only the left eye image is generated from the film images.

Then, the conversion processing unit 122 outputs the result of the film detection to the conversion processing unit 132. Note that the conversion processing unit 132 performs the IP conversion on the right-eye video data including only the right eye image. The following will specifically describe the configuration and operation of the conversion processing unit 122.

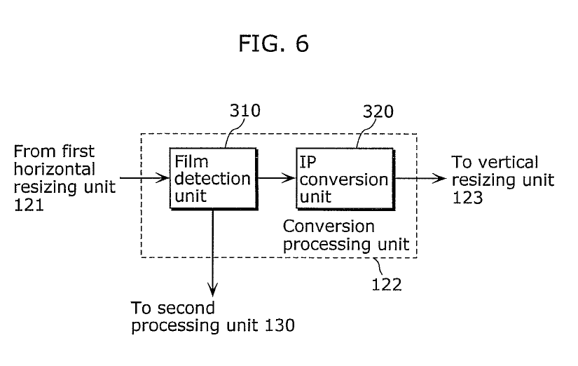

FIG. 6 is a block diagram showing an example of the configuration of the conversion processing unit 122 according to the first embodiment. As shown in FIG. 6, the conversion processing unit 122 includes a film detection unit 310 and an IP conversion unit 320.

The film detection unit 310 is an example of the information obtaining unit according to the present invention and performs the film detection on the left eye image. Specifically, the film detection unit 310, by performing the film detection on the left-eye video data including the left eye image, obtains film information indicating whether or not the input 3D video signal is a video signal generated from film images, and obtains, when the input 3D video signal is the video signal generated from the film images, picture information indicating pictures generated from the same frame among a plurality of frames included in the film images. Note that here the film detection unit 310 obtains, as an example of the picture information, IP conversion information indicating fields to be synthesized.

The IP conversion unit 320 is an example of the left-eye image processing unit according to the present invention and converts the left-eye video data from the interlace format to the progressive format, using the film information and the IP conversion information. Specifically, the IP conversion unit 320 converts the left-eye video data into the progressive format from the interlace format, using the IP conversion information, when the film information indicates that the input 3D video signal is a video signal generated from the film images. In addition, when the film information indicates that the input 3D video signal is not the video signal generated from the film images, the IP conversion unit 320 converts the left-eye video data from the interlace format into the progressive format by, for example, synthesizing two adjacent fields.

Note that the conversion processing unit 132 is an example of the right-eye image processing unit according to the present invention and performs predetermined processing on the right-eye video data. Specifically, the conversion processing unit 132 receives, from the film detection unit 310, the film information and the IP conversion information that are results of the film detection. Then, the conversion processing unit 132, in the same manner as the IP conversion unit 320, converts the right-eye video data from the interlace format into the progressive format, using the film information and the IP conversion information.

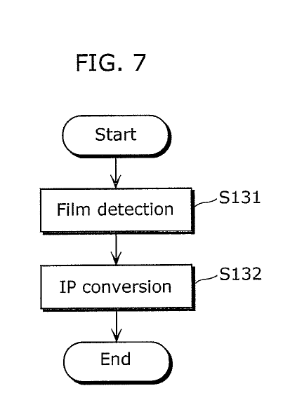

FIG. 7 is a flowchart showing an example of the operation performed by the conversion processing unit 122 according to the first embodiment.

First, the film detection unit 310 performs the film detection on the left-eye video data (S131). Note that the film detection unit 310 may perform the film detection on the right-eye video data by inputting the right-eye video data into the first processing unit 120. The film information and the IP conversion information that are results of the film detection are output to the IP conversion unit 320 and the conversion processing unit 132.

Next, the IP conversion unit 320 and the conversion processing unit 132 convert each of the left-eye video data and the right-eye video data from the progressive format to the interlace format, using the film information and the IP conversion information (S132). The following will describe specific processing in the film detection and the IP conversion, with an example of film images and 3D video.

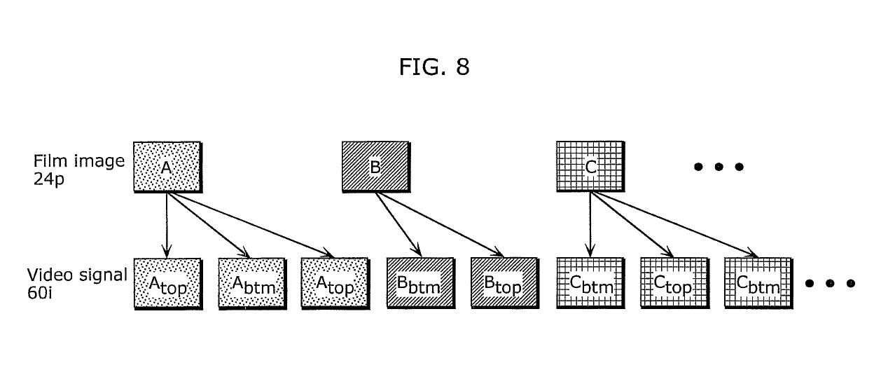

FIG. 8 is a diagram showing an example of film images and an input 3D video signal.

In the example shown in FIG. 8, the film images are video in the progressive format (24p video) including 24 frames per second (24 fps).

The input 3D video signal, for example, is a signal representing interlaced video (60i video) having a frame rate of 60 fps. In other words, the input 3D video signal includes a total of 60 top fields and bottom fields per second (the frame rate of either the top fields or the bottom fields is 30 fps).

As shown in FIG. 8, to generate 60i video from 24p video, first, a frame A included in the 24p video is read three times, for a top field (Aₜₒₚ), a bottom field (A_{btm}), and the top field (Aₜₒₚ). Next, a frame B included in the 24p video is read two times, for a bottom field (B_{btm}) and a top field (Bₜₒₚ). Next, a frame C included in the 24p video is read three times, for a bottom field (C_{btm}), a top field (Cₜₒₚ), and the bottom field (C_{btm}).

As described above, by alternately repeating reading a frame three times and reading a frame two times, it is possible to generate 60i video from the 24p video (3-2 pulldown processing). Note that for a conversion between other frame rates, the times of reading may be determined likewise according to the ratio between the frame rates before and after the conversion.

Next, the following will describe the case of performing the IP conversion for converting the 60i video (an input 3D video signal) generated as shown in FIG. 8, into 60p video (an output 3D video signal). Note that the 60p video is video of 60 fps in the progressive format.

The film detection unit 310 calculates, as the film detection, a difference between two fields. For example, the film detection unit 310 calculates the difference between a selected field and a field preceding the selected field by two fields. As shown in FIG. 8, in the input 3D video signal including the 60i video that is generated from the film images of the 24p video, two same fields are included in five fields (for example, Aₜₒₚ in first and third fields, and C_{btm} in sixth and eighth fields).

Accordingly, when sequentially calculating the difference between the two fields, a set of fields in five fields has a difference that is approximately 0. With this, the film detection unit 310 can detect that the input 3D video signal includes video generated by 3-2 pulldown, by detecting a ratio at which the difference is approximately 0. In other words, when detecting that the ratio at which the difference is approximately 0 is one set of fields out of five fields, the film detection unit 310 outputs, to the IP conversion unit 320, the film information indicating that the input 3D video signal is a video signal generated from the film images.

Furthermore, when detecting that the ratio at which the difference is approximately 0 is one set of fields out of five fields, the film detection unit 310 obtains the frame rate information indicating the frame rate of the film images. In other words, the information that the input three-dimensional video signal is video generated by 3-2 pulldown and the frame rate of the input 3D video signal is 60 fps shows that the frame rate of the film images is 24 (=60×2/5) fps. Then, in performing the IP conversion, the film detection unit 310 outputs, to the IP conversion unit 320, the IP conversion information indicating the top field and the bottom field that are to be synthesized.

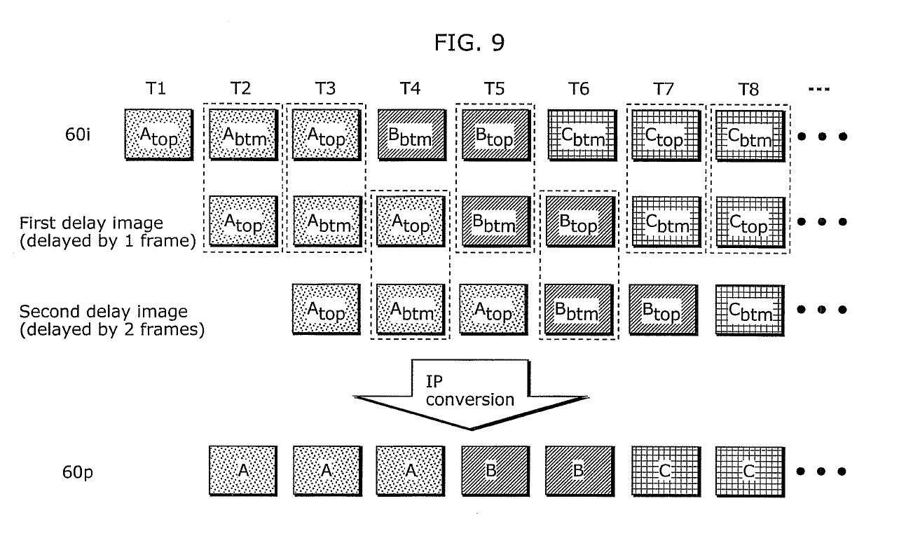

FIG. 9 is a diagram showing an example of processing for performing the IP conversion, from the video of 60i into the video of 60p by the IP conversion unit 320 according to the first embodiment.

The IP conversion unit 320 selects and synthesizes two images for each field, from among: an input image of 60i, a first delay image generated by delaying the input image of 60i by one frame, and a second delay image generated by delaying the input image of 60i by two frames. In this processing, which image is to be selected, that is, which top field and which bottom field are to be selected is determined according to the IP conversion information that is a result of the film detection by the film detection unit 310.

Specifically, when detecting that the input 3D video signal is a video signal generated by 3-2 pulldown, the film detection unit 310 outputs, as the IP conversion information, information indicating fields generated from the same frame in the film images. Then, the IP conversion unit 320 selects the fields generated from the same frame according to the IP conversion information received, and synthesizes the selected fields.

For example, the IP conversion unit 320 generates a frame of picture by synthesizing two fields enclosed by a dotted square shown in FIG. 9.

Specifically, at time T2, the IP conversion unit 320 synthesizes Aₜₒₚ of a first delay image and A_{btm} of the 60i image In addition, at time T3, the IP conversion unit 320 synthesizes A_{btm} of the first delay image and Aₜₒₚ of the 60i image. Note that at time T3, A_{btm} of the first delay image and Aₜₒₚ of a second delay image may be synthesized.

Furthermore, at time T4, the IP conversion unit 320 synthesizes Aₜₒₚ of the first delay image and A_{btm} of the second delay image. Next, at time T5, the IP conversion unit 320 synthesizes Bₜₒₚ of the 60i image and A_{btm} of the first delay image.

Thus, when performing the IP conversion on the video signal generated by 3-2 pulldown, for three consecutive fields generated from the same frame, the first delay image and the input image may be synthesized for the first two images, and the first delay image and the second delay image may be synthesized for the one remaining image. Note that the image in the middle may be generated by synthesizing the first delay image and the second delay image. Furthermore, for two consecutive fields generated from the same frame, the first delay image and the input image may be synthesized for a first image, and the first delay image and the second delay image may be synthesized for a second image.

As described above, the IP conversion unit 320 generates a progressive output 3D video signal having the same frame rate from an interlaced input 3D video signal having a predetermined frame rate, by selecting and synthesizing the fields generated from the same frame in the film images.

In addition, when the film information indicates that the input 3D video signal is not a video signal generated from the film images, the IP conversion unit 320 generates the progressive output 3D video signal by sequentially synthesizing adjacent fields.

Note that in the case of the input 3D video signal being a video signal generated from the film images, when the IP conversion unit 320 simply synthesizes the adjacent fields sequentially without performing the film detection, for example, Aₜₒₚ and B_{btm} are to be synthesized, thus causing deterioration in image quality. Thus, by performing the film detection as described above, the IP conversion unit 320 according to the present embodiment allows synthesizing the fields generated from the same frame in the film images, thus preventing deterioration in image quality.

As described above, the conversion processing unit 122 according to the first embodiment performs the film detection on the left-eye video data, and outputs the result to the conversion processing unit 132. The conversion processing unit 132 performs the IP conversion on the right-eye video data, using the result of the film detection that is input from the conversion processing unit 122.

The left eye image and the right eye image are essentially images obtained by imaging the same object from different viewpoints or images generated by displacing the same image by a predetermined amount of parallax. Accordingly, on whichever one of the left-eye video data and the right-eye video data the film detection may be performed, the same result can be obtained.

Thus, as described in the present embodiment, it is possible to avoid overlaps in the processing by performing the film detection on either the left-eye video data or the right-eye video data, and using the result of the detection for both the left-eye video data and the right-eye video data. This allows the video signal processing apparatus 100 according to the present embodiment to avoid redundant processing, thus reducing power consumption and increasing the processing speed.

In addition, when performing the detection, separately, on the left-eye video data and the right-eye video data, there is a possibility of obtaining detection results that are different from each other. In this case, since the conversion processing units 122 and 132 are to perform the IP conversion based on different detection results, there is a possibility of an unnatural image being generated when the synthesizing unit 140 synthesizes the left eye image and the right eye image.

In contrast, with the video signal processing apparatus 100 according to the present embodiment, since both the left image and the right image are processed using the same detection result, it is possible to reduce the possibility of an unnatural image being generated as described above.

Note that the configuration in which the film detection is performed on the interlaced input 3D video signal has been described above, but the film detection may be performed on a progressive input 3D video signal. For example, the case is assumed where the video signal processing apparatus 100 according to the present embodiment receives, as an input 3D video signal, a 60p video signal (AAABBCCC . . . ) as shown in FIG. 9, which is generated from 24p film images (ABC . . . ) as shown in FIG. 8.

The film detection unit 310 calculates the difference between two frames included in the left-eye video data. For example, when the film detection unit 310 calculates the difference between two temporally adjacent frames, the difference results in “small, small, large, small, large, small, small, large, small, large . . . ”. With this processing, the film detection unit 310 outputs, to the IP conversion unit 320, film information indicating that the input 3D video signal includes video generated by 3-2 pulldown.

Furthermore, the film detection unit 310 outputs, to the IP conversion unit 320 and the conversion processing unit 132, frame information indicating the frames generated from the same frame in the film images, as an example of the picture information. For example, when the difference between two temporally adjacent frames is approximately 0, the film detection unit 310 outputs the frame information based on a determination that these two frames are generated from the same frame included in the film images.

The IP conversion unit 320 receives the film information and the frame information, and converts the frame rate of the input 3D video signal that is the left-eye video data, based on the received film information and frame information. For example, when the film information indicates that the input 3D video signal includes video generated by 3-2 pulldown, the IP conversion unit 320 determines which frames to be output and the number of the frames to be output, using the frame information.

For example, the IP conversion unit 320 outputs a video signal (AABBCC . . . ) having a frame rate of 48 fps, by selecting and outputting the same frames in units of two frames. This video signal includes each set of two same frames. Alternatively, the IP conversion unit 320 may output a video signal of (AAAAABBBBBCCCCC . . . ) having a frame rate of 120 fps, by selecting and outputting the same frames in units of five frames. This video signal includes each set of five same frames.

The conversion processing unit 132 performs the same processing on the right-eye video data as the IP conversion unit 320.

As described above, the film detection may be performed on the progressive input 3D video signal. In this case as well, since the same result is obtained from the film detection on the left-eye video data and the right-eye video data, it is possible to suppress increase in the amount of processing.

Note that the IP conversion unit 320 may perform both the scanning mode conversion and the frame rate conversion. For example, the IP conversion unit 320 converts an interlaced video signal (60i video signal) to a progressive video signal (60p video signal), and also converts the frame rate of the converted video signal as described above. This allows, for example, the IP conversion unit 320 to generate a 48p or 120p video signal from the 60i video signal.

In addition, in the film detection, the video signal generated by 3-2 pulldown has been described as the input 3D video signal, but the input 3D signal may be a video signal generated by 2-2 pulldown. For example, in the case of the video signal generated by 2-2 pulldown, when calculating the difference between two adjacent fields, a resultant difference alternately repeats a pattern of “large, small, large, small, . . . ”. This allows the film detection unit 310 to detect that the input 3D video signal is a video signal generated by 2-2 pulldown, based on a determination on a variation tendency of the detected difference.

Note that the film detection performed by the film detection unit 310 is not limited to the above method but may be another method.

In addition, the video signal processing apparatus 100 according to the present embodiment has been described as having a configuration in which the left-eye video data and the right-eye video data are processed in parallel using the first processing unit 120 and the second processing unit 130, but the video signal processing apparatus 100 may include only one of the two processing units. For example, the input selection unit 110 may input both the left-eye video data and the right-eye video data into the first processing unit 120.

Each processing unit included in the first processing unit 120 sequentially processes a corresponding one of the left-eye video data and the right-eye video data. For example, after processing the left-eye video data, the right-eye video data may be processed (and vice versa). In this processing, the film information and the IP conversion information that have been obtained from the left-eye video data may be stored on a memory or the like.

In addition, according to the present embodiment, the film detection has been performed on the left eye image, but the film detection may be performed on the right eye image, and the result of the detection may be used for both the left eye image and the right eye image.

As described above, the video signal processing apparatus 100 according to the first embodiment includes the film detection unit 310 that is an example of the information obtaining unit which obtains, from one of the left eye image and the right eye image, information used for performing predetermined processing such as the IP conversion. In addition, the video signal processing apparatus 100 includes the IP conversion unit 320 and the conversion processing unit 132 each of which is an example of the image processing unit which performs the IP conversion or the frame rate conversion on both the left eye image and the right eye image, using the information obtained by the film detection unit 310 that is an example of the information obtaining unit.

With this configuration, with the video signal processing apparatus 100 according to the first embodiment, it is only necessary to perform, only on one of the left eye image and the right eye image, the film detection that is an example of the processing for obtaining the information described above, thus allowing avoiding overlaps in the processing. Accordingly, it is possible to suppress increase in the amount of processing.

### Second Embodiment

A video signal processing apparatus according to a second embodiment includes, as in the first embodiment: an information obtaining unit which obtains, from one of the left eye image and the right eye image, image feature information used for performing predetermined processing; and an image processing unit which performs the processing on both the left eye image and the right eye image, using the information obtained by the information obtaining unit. More specifically, in the second embodiment, the information obtaining unit obtains specific image information indicating a region including the specific image, by detecting whether or not a specific image having a constant luminance value is included in one of the left eye image and the right eye image.

Note that hereinafter the description that overlaps with the description in the first embodiment will be omitted, and the description will be given centering on the difference from the first embodiment.

The video signal processing apparatus according to the second embodiment is almost the same as the video signal processing apparatus 100 according to the first embodiment as shown in FIG. 3, and is different from the video signal processing apparatus 100 according to the first embodiment in including an input selection unit 410 in place of the input selection unit 110. The following will described the configuration of the input selection unit 410 included in the video signal processing apparatus according to the second embodiment.

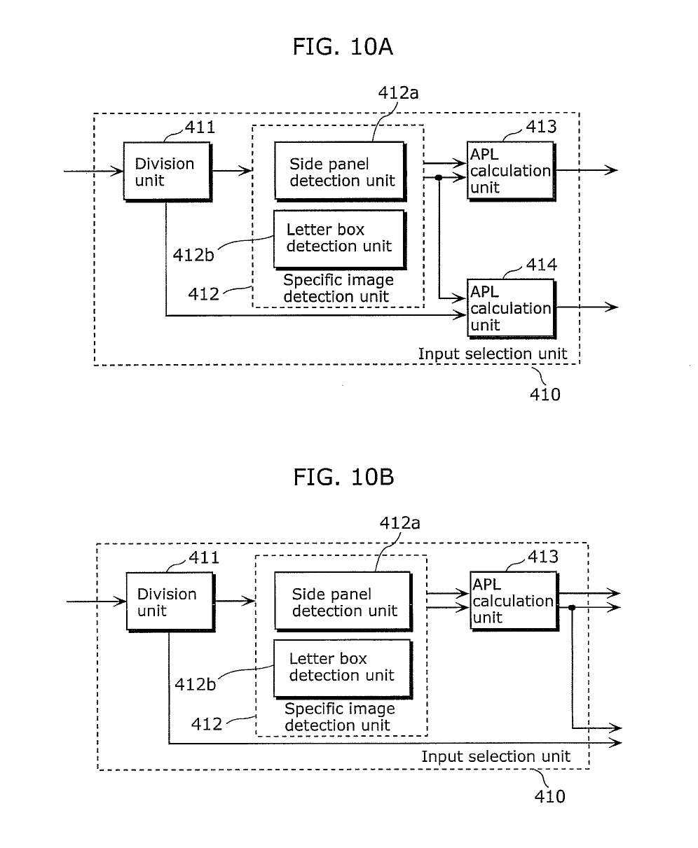

FIGS. 10A and 10B are block diagrams each showing an example of a configuration of the input selection unit 410 included in the video signal processing apparatus according to the second embodiment. As shown in FIG. 10A, the input selection unit 410 includes: a division unit 411, a specific image detection unit 412, and APL calculation units 413 and 414.

The division unit 411 divides the input 3D video signal into the left eye image and the right eye image. The left eye image is output to the specific image detection unit 412, and the right eye image is output to an APL calculation unit 414. Note that the left eye image may be output to the APL calculation unit 414, and the right eye image may be output to the specific image detection unit 412.

In addition, when the input 3D video signal is divided into the left eye image and the right eye image in advance, the input selection unit 410 need not include the division unit 411. In this case, the left eye image is directly input into the specific image detection unit 412, and the right eye image is directly input into the APL calculation unit 414.

The specific image detection unit 412 is an example of the information obtaining unit according to the present invention, and obtains the specific image information indicating the region including the specific image, by detecting whether or not a specific image having a constant luminance value is included one of the left eye image and the right eye image. Here, since the left eye image is input, the specific image detection unit 412 detects whether or not the left eye image includes the specific image. Specifically, the specific image detection unit 412 performs side panel detection and letter box detection.

As shown in FIG. 10A, the specific image detection unit 412 includes a side panel detection unit 412a and a letter box detection unit 412b.

The side panel detection unit 412a detects whether or not one of the left eye image and the right eye image includes the specific image on the right and left sides of the image (side panel detection or pillar box detection). Here, since the left eye image is input, the side panel detection unit 412a detects whether or not the left eye image includes the specific image on both the right and left sides. Note that the specific image is an image having a constant luminance value, for example, a black image.

The side panel detection unit 412a obtains, by performing the side panel detection, the specific image information indicating the region including the specific image. The specific image information is, for example, information indicating how many pixels, from the right or left of the image, are included in the region including the specific image.

The letter box detection unit 412b detects whether or not one of the left eye image and the right eye image includes the specific image at the top and bottom of the image (letter box detection). Here, since the left eye image is input, the letter box detection unit 412b detects whether or not the left eye image includes the specific image at the top and the bottom.

The letter box detection unit 412b obtains the specific image information indicating the region including the specific image by performing the letter box detection. The specific image information is information indicating how many pixels, from the top or bottom of the image, are included in the region including the specific image.

Note that the specific image detection unit 412 may perform only one of the side panel detection and the letter box detection. When performing both detections, the specific image detection unit 412 outputs, to the APL calculation units 413 and 414, both of the information obtained by the side panel detection unit 412a and the specific image information obtained by the letter box detection unit 412b, as the specific image information indicating the region including the specific image.

The APL calculation units 413 and 414 are an example of the image processing unit according to the present invention, and calculate, for each of the left eye image and the right eye image, an average luminance value (average picture level) of an effective image region that is other than the region indicated by the specific image information. Specifically, the APL calculation unit 413 calculates the average luminance value of the effective image region that is included in the left eye image and is other than the region indicated by the specific image information. In addition, the APL calculation unit 414 calculates the average luminance value of an effective image region that is included in the right eye image and is other than the region indicated by the specific image information. Note that the effective image region is a region in which an original image is displayed.

Here, an example of the specific image is described.

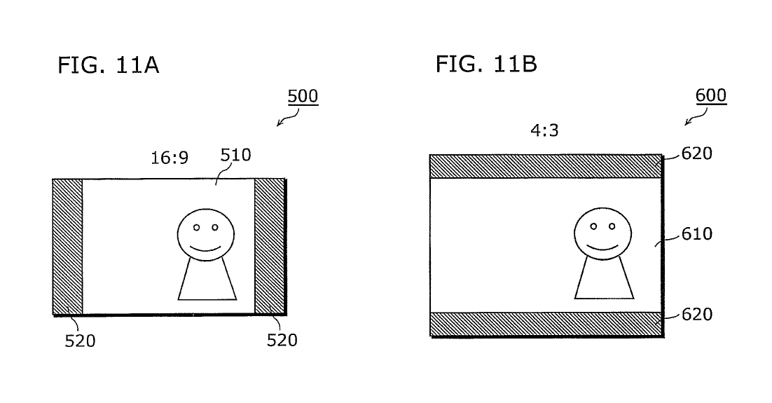

FIG. 11A is a diagram showing an example of a side panel image 500. FIG. 11B is a diagram showing an example of a letter box image 600.

In the side panel image 500, a specific image 520 is added to each of the right and left sides of an original image 510. Specifically, when displaying the original image 510 having an aspect ratio 4:3 on a screen having an aspect ratio 16:9, the specific images 520 are added to the original image 510. Note that the side panel is also called a pillar box.

The side panel detection unit 412a detects whether or not the specific images 520 as shown in FIG. 11A are added to the original image 510. For example, the side panel detection unit 412a determines whether or not all the luminance values of the pixels included in both a left region (a region including some columns of pixels) and a right region (a region including some columns of pixels) of the input left eye image are the same predetermined value (black).

When determining that all the luminance values of the pixels included in the left and right regions are the same predetermined value (black), the side panel detection unit 412a determines that the input left eye image is the side panel image 500. Then, the side panel detection unit 412a outputs, to the APL calculation unit 413, the specific image information indicating the region of the specific image 520. The APL calculation unit 413 calculates the average luminance value of a region in the side panel image 500 excluding the specific image 520 (effective image region), that is, the original image 510.

When calculating the average luminance value of the side panel image 500, the average luminance value is calculated including the specific image 520 having a constant luminance value. That is, a value different from the average luminance value of the original image 510 is calculated. As a result, in such cases as correcting the image using the average luminance value, it is not possible to accurately correct the image due to the difference in the average luminance value. In contrast, according to the present embodiment, it is possible to perform accurate correction processing by performing the side panel detection and specifying the region of the specific image.

In the letter box image 600, a specific image 620 is added to each of the top and bottom of an original image 610. Specifically, when displaying the original image 610 having an aspect ratio 4:3 on a screen having an aspect ratio 16:9, the specific images 620 are added to the original image 610.

The letter box detection unit 412b detects whether or not the specific images 620 as shown in FIG. 11B are added to the original image 610. For example, the letter box detection unit 412b determines whether or not all the luminance values of the pixels included in both a top region (a region including some columns of pixels) and a bottom region (a region including some columns of pixels) of the input right eye image are the same predetermined value (black).

When determining that all the luminance values of the pixels included in both the top and bottom regions are the predetermined value (black), the letter box detection unit 412b determines that the right eye image that is input is the letter box image 600. Then, the letter box detection unit 412b outputs, to the APL calculation unit 413, the specific image information indicating the region of the specific image 520. The APL calculation unit 413 calculates the average luminance value of a region in the letter box image 600 excluding the specific image 620 (effective image region), that is, the original image 610. With this, as with the side panel detection, it is possible to accurately perform correction processing by performing the letter box detection and specifying the region of the specific image.

Note that the aspect ratio described above is a mere example, and the same is applicable to the case of using another aspect ratio.

As described above, using the specific image information detected from the left eye image, the APL calculation unit 414 calculates the average luminance value of the right eye image. Normally, there is no case where only one of the left eye image and the right eye image includes the specific image, nor is the specific image included in different regions. Therefore, the specific image information detected from the left eye image almost matches the specific image information detected from the right eye image.

Thus, when it is not necessary to obtain a precise result, the processing of obtaining the specific image information from both the left eye image and the right eye image is redundant, and thus it is possible to suppress increase in the amount of processing by obtaining the specific image information from only one of the images as described in the present embodiment. Note that when it is necessary to obtain a precise result, the side panel detection unit 412a and the letter box detection unit 412b may perform the side panel detection and the letter box detection, respectively, on each of the left eye image and the right eye image.

Note that as shown in FIG. 10B, the input selection unit 410 need not include the APL calculation unit 414. In other words, the average luminance value calculated by the APL calculation unit 413 from the left eye image may be used as the average luminance value for the right eye image. This is because the average luminance value of the left eye image and the average luminance value of the right eye image are highly likely to be the same. Note that the APL calculation unit 413 in this context is an example of the information obtaining unit according to the present invention.

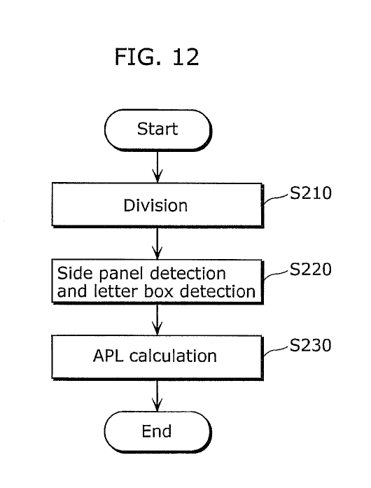

Subsequently, of the operation of the video signal processing apparatus according to the second embodiment, an operation of the input selection unit 410 will be described with reference to FIG. 12. Note that the operation of the video signal processing apparatus according to the second embodiment is almost the same as the operation of the video signal processing apparatus 100 according to the first embodiment (see FIG. 4), and is different in the operation of the input selection unit 110 (S110).

FIG. 12 is a flowchart showing an example of the operation performed by the input selection unit 410 included in the video signal processing apparatus according to the second embodiment. FIG. 12 corresponds to the operation (S110) of the input selection unit 110 shown in FIG. 4.

First, the division unit 411 divides the input 3D video signal into the left eye image and the right eye image (S210). The left eye image is output to the specific image detection unit 412, and the right eye image is output to the APL calculation unit 414.

Next, the specific image detection unit 412 performs the side panel detection and the letter box detection on the left eye image (S220). Note that only one of the side panel detection and the letter box detection may be performed. For example, it is not necessary to perform the letter box detection when the specific image is detected by the side panel detection. Conversely, it is not necessary to perform the side panel detection when the specific image is detected by the letter box detection. The specific image information that is the result of the detection is output to both of the APL calculation units 413 and 414.

Next, the APL calculation unit 413 calculates the average luminance value of the left eye image using the specific image information, and the APL calculation unit 414 calculates the average luminance value of the right eye image using the specific image information (S230).

As described above, in the video signal processing apparatus according to the second embodiment, the input selection unit 410 detects the specific image by performing the side panel detection and the letter box detection on the left eye image, and calculates, using the result of the detection, the average luminance value for each of the left eye image and the right eye image.

With this, the video signal processing apparatus according to the second embodiment allows suppressing the amount of processing by obtaining the specific image information from only one of the left eye image and the right eye image.

Note that in the second embodiment, the input selection unit 410 performs the side panel detection and the letter box detection, but as in the first embodiment, the conversion processing unit 122 may perform these detections on the left eye image. Then, the conversion processing unit 122 may output the obtained results of the detection to the conversion processing unit 132.

In addition, likewise, the average luminance value may be calculated not by the input selection unit 410 but by the conversion processing units 122 and 132. Alternatively, the calculation may be performed by another processing unit that is not shown in the figure.

As described above, the video signal processing apparatus according to the present invention is a three-dimensional video signal processing apparatus including the left eye image and the right eye image, and performs the predetermined processing on both the left eye image and the right eye image, using the information obtained from one of the left eye image and the right eye image. This utilizes the fact that the left eye image and the right eye image have much in common because both images are normally obtained by imaging the same object from different viewpoints.

For example, as described above, the results of the film detection, the side panel detection, and the letter box detection are common between the left eye image and the right eye image. Accordingly, for a process that produces the same result, it is possible to avoid processing overlaps by performing the process only on one of the images, thus suppressing increase in the amount of processing.

In addition, when a different result is obtained where the same result should have normally been obtained, there is a possibility of an unnatural image being generated when synthesizing the left eye image and the right eye image. Since the video signal processing apparatus according to the present invention uses the same result, it is possible to prevent generation of such an unnatural image.

As described above, the video signal processing apparatus and the image signal processing method have been described based on the embodiments, but the present invention is not limited to these embodiments. Those skilled in the art will readily appreciate that many modifications are possible in the exemplary embodiments without departing from the novel teachings and advantages of this invention. Accordingly, all such modifications are intended to be included within the scope of this invention.

For example, a CM detection may be performed on one of the left eye image and the right eye image. The CM detection is processing for determining whether an input of the left eye image or the right eye image is a commercial message (CM) such as advertising information included in the video or content such as a movie. Normally, it is impossible that only one of the left eye image and the right eye image is the commercial message at the same display time, so that the result of the CM detection is the same for the left eye image and the right eye image.

Accordingly, it is possible to perform the CM detection on one of the left eye image and the right eye image, and use the obtained result as the result of the CM detection for both of the left eye image and the right eye image. Note that, for example, the input selection unit 110 or 410 performs the CM detection. For example, by detecting an identifier indicating that the image is a commercial message or detecting a difference in resolution between the commercial message and content, it is determined whether or not the input of the left eye image or the right eye image is a commercial message.

When the left eye image is determined to be the commercial message, for example, the first horizontal resizing units 121 and 131 can reduce the amount of the subsequent processing by reducing the left eye image and the right eye image at a high reduction ratio.

In addition, to prepare for coding the 3D video signal that is input, motion may be detected from one of the left-eye video data including the left eye image and the right-eye video data including the right eye image. In addition, likewise, a reference relationship of the frame or field may be determined. These processes are performed by, for example, the input selection unit 110 or 410, the conversion processing unit 122 or 132, or another processing unit.

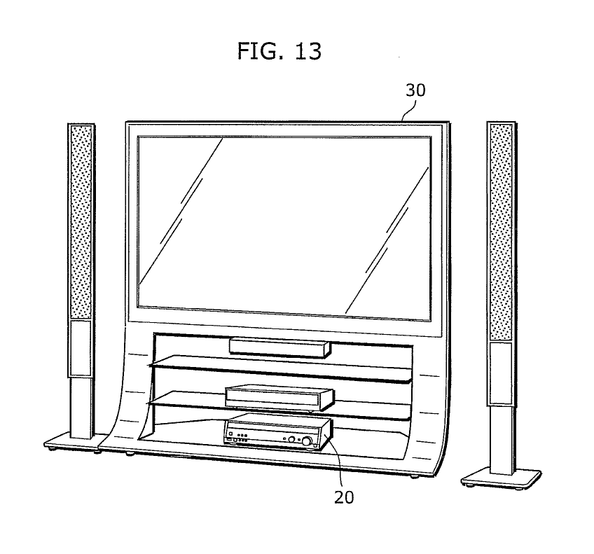

Note that the video signal processing apparatus 100 according to an implementation of the present invention is incorporated in the digital video recorder 20 and the digital television 30 as shown in FIG. 13.

Note that the present invention has been described based on the embodiments above, but it goes without saying that the present invention is not limited to these embodiments. The following cases are also included in the scope of the present invention.

Specifically, each of the apparatuses described above is a computer system which includes: a microprocessor, a read-only memory (ROM), a random access memory (RAM), a hard disk unit, a display unit, a keyboard, a mouse, and so on. On the RAM or the hard disk unit, a computer program is stored. Each apparatus performs its function by the microprocessor operating according to the computer program. Here, the computer program is configured by combining a plurality of instruction codes each indicating an instruction for the computer to perform a predetermined function.

Part or all of the constituent elements included in each of the apparatuses described above may include a single system LSI. The system LSI is a super-multifunctional LSI manufactured by stacking the constituent elements on a single chip, and is specifically a computer system including a microprocessor, a ROM, a RAM, and so on. On the RAM, a computer program is stored. By the microprocessor operating according to the computer program, the system LSI performs its function.

Part or all of the constituent elements included in each of the apparatuses described above may include an IC card or single module that is removable for each apparatus. The IC card or the module is a computer system including a microprocessor, a ROM, a Ram, and so on. The IC card or the module may include the super-multifunctional LSI described above. By the microprocessor operating according to the computer program, the IC card or the module performs its function. This IC card or module may have tamper resistance.

In addition, the present invention may be realized as the methods described above. In addition, these methods may be realized as a computer program for realizing these methods by a computer, or may be a digital signal representing the computer program.

In addition, the present invention may be realized as a computer program or digital signal that is recorded on a non-transitory computer-readable recording medium: for example, a flexible disk, a hard disk, a compact disc read only memory (CD-ROM), a magneto-optical disk (MO), a digital versatile disc (DVD), a digital versatile disc read only memory (DVD-ROM), a digital versatile disc random access memory (DVD-RAM), a Blu-ray disc (BD), or a semiconductor memory. In addition, the present invention may be realized as a digital signal recorded on such recording media.

In addition, the present invention may be realized as a computer program or digital signal transmitted via an electrical communication line, a wireless or wired communication line, a network represented by the Internet, data broadcasting, and so on.

In addition, the present invention may be realized as a computer system including a microprocessor and a memory, in which the memory stores the computer program described above, and the microprocessor operates according to the computer program.

In addition, the program or the digital signal may be performed by another independent computer system by recording on a recording medium and transferring the program or the digital signal, or transferring the program or the digital signal via the network and so on.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A video signal processing apparatus and an image signal processing method according to the present invention produce an advantageous effect of suppressing increase in amount of processing, and are applicable to, for example, a digital television and a digital vide recorder.

What is claimed is:

1. A video signal processing apparatus which processes a three-dimensional (3D) video signal including a left eye image and a right eye image, said video signal processing apparatus comprising:
an information obtaining unit configured to obtain, from one of the left eye image and the right eye image, image feature information used for performing predetermined processing; and
an image processing unit configured to perform the predetermined processing on both the left eye image and the right eye image, using the image feature information obtained by said information obtaining unit.

2. The video signal processing apparatus according to claim 1,
wherein said information obtaining unit is configured to obtain film information by performing film detection on the one of the left eye image and the right eye image, the film information indicating whether or not the 3D video signal is a video signal generated from film images.

3. The video signal processing apparatus according to claim 2,
wherein said information obtaining unit is further configured to obtain picture information when the 3D video signal is the video signal generated from the film images, the picture information indicating pictures generated from a same frame among a plurality of frames in the film images, and
when the film information indicates that the 3D video signal is the video signal generated from the film images, said image processing unit is configured to perform, using the picture information, at least one of a scanning mode conversion and a frame rate conversion as the predetermined processing on each of the left eye image and the right eye image.

4. The video signal processing apparatus according to claim 1,
wherein said information obtaining unit is configured to obtain specific image information by detecting whether or not the one of the left eye image and the right eye image includes a specific image having a constant luminance value, the specific image information indicating a region including the specific image.

5. The video signal processing apparatus according to claim 4,
wherein said information obtaining unit is configured to obtain the specific image information by detecting whether or not the one of the left eye image and the right eye image includes the specific image on right and left sides of the one of the left eye image and the right eye image.

6. The video signal processing apparatus according to claim 4,
wherein said information obtaining unit is configured to obtain the specific image information by detecting whether or not the one of the left eye image and the right eye image includes the specific image on top and bottom sides of the one of the left eye image and the right eye image.

7. The video signal processing apparatus according to claim 5,
wherein said image processing unit is configured to calculate, for each of the left eye image and the right eye image, an average luminance value of an effective image region that is other than the region indicated by the specific image information.

8. The video signal processing apparatus according to claim 1, further comprising
a division unit configured to divide the 3D video signal into the left eye image and the right eye image,
wherein said image processing unit includes:
a left-eye image processing unit configured to perform the predetermined processing on the left eye image; and
a right-eye image processing unit configured to perform the predetermined processing on the right eye image, and
said information obtaining unit is configured to obtain the image feature information from the one of the left eye image and the right eye image that have resulted from the division by said division unit, and to output the obtained image feature information to said left-eye image processing unit and said right-eye image processing unit.

9. A video signal processing method for processing a three-dimensional (3D) video signal including a left eye image and a right eye image, said video signal processing method comprising:
obtaining, from one of the left eye image and the right eye image, image feature information used for performing predetermined processing; and
performing the predetermined processing on both the left eye image and the right eye image, using the image feature information obtained in said obtaining.

10. An integrated circuit which processes a three-dimensional (3D) video signal including a left eye image and a right eye image, said integrated circuit comprising:
an information obtaining unit configured to obtain, from one of the left eye image and the right eye image, image feature information used for performing predetermined processing; and
an image processing unit configured to perform the predetermined processing on both the left eye image and the right eye image, using the image feature information obtained by said information obtaining unit.

11. A non-transitory computer-readable recording medium for use in a computer, which holds a program for causing the computer to execute a video signal processing method for processing a three-dimensional (3D) video signal including a left eye image and a right eye image,
wherein the program includes:
obtaining, from one of the left eye image and the right eye image, image feature information used for performing predetermined processing; and
performing the predetermined processing on both the left eye image and the right eye image, using the image feature information obtained in the obtaining.
